(19) United States
(12) Patent Application Publication
(10) Pub. No.: US 2004/0169877 A1
(43) Pub. Date: Sep. 2, 2004

(54) Image forming apparatus and method for visually displaying image data of various data formats

(75) Inventor: Tetsuya Sadowara, Shizuoka-ken (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/786,415

(22) Filed: Feb. 26, 2004

(30) Foreign Application Priority Data
Feb. 28, 2003 (JP) 2003-054319

(51) Int. Cl. G06F 3/12; H04N 1/60; G06F 13/00

(52) U.S. Cl. 358/1.13; 358/1.9; 358/518

(57) ABSTRACT

Image data of various data formats stored in the storage of the MFP can be visually displayed on the display as an image after converting format of image data stored in the storage to a predetermined format by the data format converter.

### CROSS REFERENCE TO RELATED APPLICATION

This application is based upon and claims the benefit of priority from the prior Japanese Patent Application No. 2003-54319 filed on Feb. 28, 2003; the entire contests of which are incorporated herein by reference.

### FIELD OF THE INVENTION

The present invention relates generally to an image forming apparatus having a display and a storage, and in particular it relates to an image forming apparatus that visually displays an image data stored in the storage as an image.

### DISCRIPTION OF THE BACKGROUND

Generally, a MFP (Multi Function Peripheral) which has a color copying function, a network scanning function, a color printing function, a storage function, and a data management function, is known. FIG. 1 shows such a conventional MFP1.

The MFP 1 is controlled by a CPU 2. When the MFP 1 is used as a color-copying machine, the image of an original is read by a scanner 3 to generate an image data in RGB format from the original.

A color conversion processing is performed on the image data by a scanner image processor 4 to convert the format of the image data from RGB to YMC. After that, the image data is compressed to reduce a memory space where the image data is stored. By the compression processing, the format of the image data is changed to YCbCr format. The image data in YCbCr format includes color difference information and luminance information.

The image data is stored in a page memory 5 temporarily, and is then stored in a storage 6 when the compression is completed.

The image data in YCbCr format stored in the storage 6 is read out to the page memory 5 again, and is extended by a printer image processor 7. By the extension processing, the format of the image data is changed to YMC. The printer image processor 7 further processes a black-component-generation processing on the image data to convert the format of the image data from YMC to YMCK.

A printer 8 prints the image based on the image data to duplicate the original. Before the printing or during the printing, the image data read from the original by the scanner 3 is used to display an image on a control panel 9.

When the MFP 1 is used as a network scanner, the original is scanned by the scanner 3 to generate an image data in RGB format. The scanner image processor 4 then converts the format of the image data from RGB to YCbCr. This conversion is a preprocessing for conversion to JPEG (Joint-Photographic-Image-Experts-Group) format.

The image data in YCbCr format that contains color-difference information Cb and Cr and luminance information Y is stored in the page memory 5 temporarily, and is stored in the storage 6 from the page memory 5. When the conversion is completed, the image data stored in the storage 6 is read out by a controller 10. The controller 10 outputs the image data to a PC (Personal Computer) 12 through a network 11.

When the MFP 1 is used as a color printer, a print data sent from the PC 12 through the network 11 and the controller 10, is stored in the storage 6 in YMCK format.

The image data stored in the storage 6 is read out to the page memory 5, and an image processing is performed on the image data by the printer image processor 7. The printer 8 performs a printing according to the image data.

As described above, an image data is stored in the storage 6 in various formats which are required by an operation mode of each function.

In the conventional MFP 1, an image is displayed on the control panel 9 using the image data of RGB format. However, an image data stored in the storage 6 in various formats other than RGB format can not be displayed on the control panel 9.

Therefore, to visually confirm an image data stored in the storage 6 in various formats, it is not evitable to print the image data on a paper if the format of the image data is not coincident with a predetermined format which can be used to display an image based on the image data.

### SUMMARY OF THE INVENTION

Briefly, in one aspect of the invention, an image forming apparatus includes a storage configured to store an image data of a first format. The image forming apparatus also includes a display configured to display an image based on an image data of a predetermined format. The image forming apparatus still also includes a data format converter configured to convert the image data of the first format stored in the storage to the image data of the predetermined format when the image data of the first format stored in the storage is visually displayed on the display as an image.

### BRIEF DESCRIPTION OF THE DRAWINGS

FIG. 1 is a schematic diagram illustrating a conventional MFP.

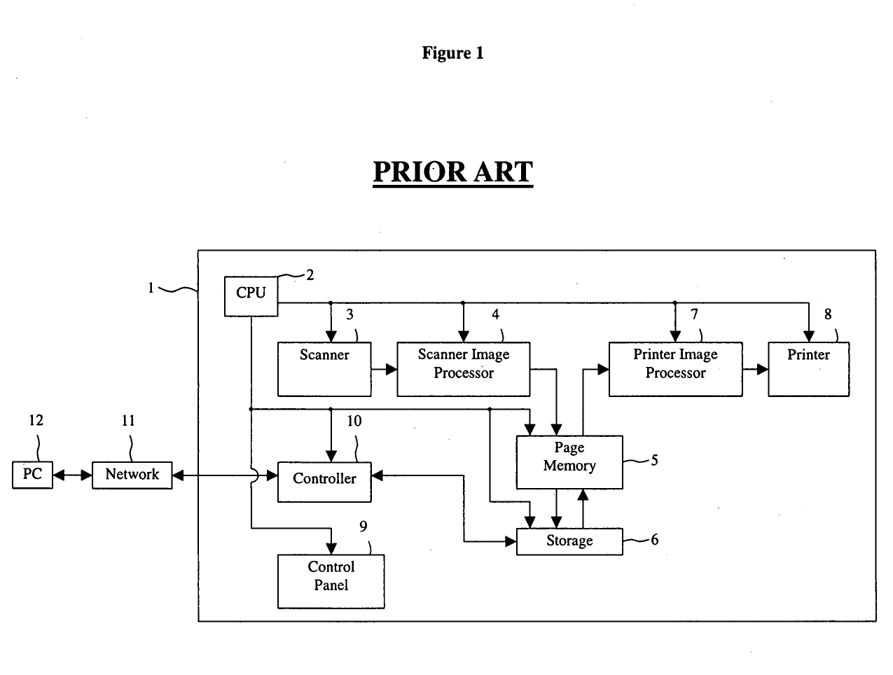

FIG. 2 is a schematic diagram illustrating the MFP of an embodiment of this invention.

FIG. 3 is a flow chart illustrating the image display processing steps of an embodiment of the invention.

### DETAILED DESCRIPTION OF THE INVENTION

Embodiments of the present invention will be disclosed in reference to the accompanying drawings.

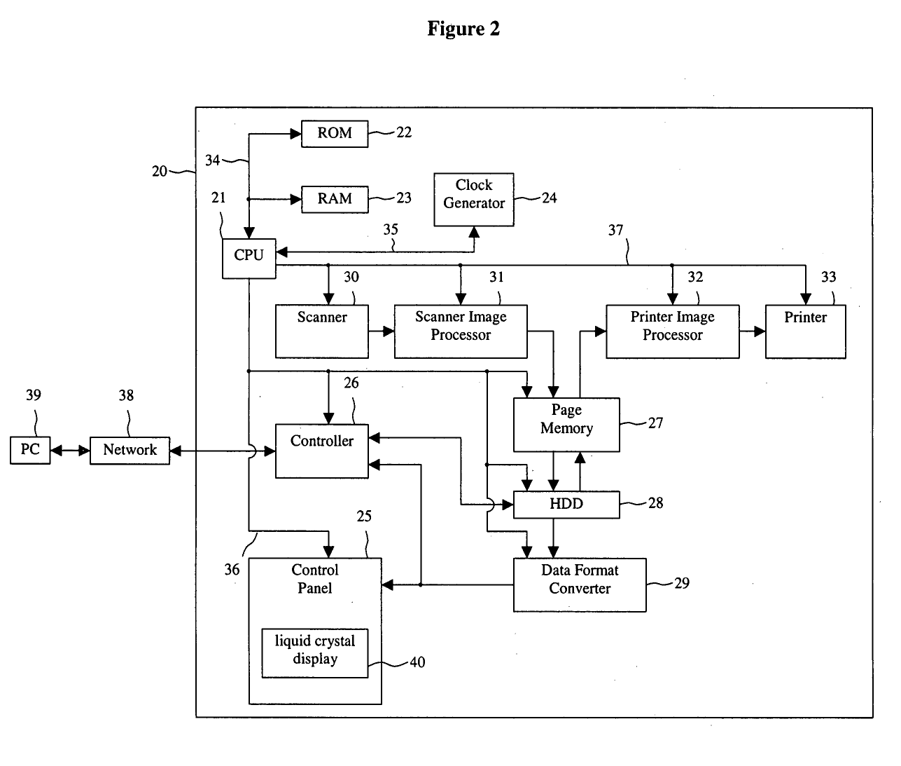

As shown in FIG. 2, a MFP 20 includes a CPU (Central Processing Unit) 21, a ROM (Read Only Memory) 22, a RAM (Random Access Memory) 23, a clock generator 24, a control panel 25, a controller 26, a page memory 27, a HDD (Hard Disk Drive) 28, a data format converter 29, a scanner 30, a scanner image processor 31, a printer image processor 32 and a printer 33.

The ROM 22 and the RAM 23 are connected with the CPU 21 respectively through a bus line 34. The clock generator 24 is connected with the CPU 21 through a bus line 35 to provide a system clock. The control panel 25, the controller 26, the page memory 27, the HDD 28, and the data format converter 29 are connected with the CPU 21 respectively through a bus line 36. The page memory 27, the HDD 28 and the data format converter 29 are connected in series. The HDD 28 and the controller 26 are connected and, the output of the data format converter 29 is connected to both the controller 26 and the control panel 25 respectively.

The scanner 30, the scanner image processor 31, the printer image processor 32, and the printer 33 are connected with the CPU 21 respectively through a bus line 37. The output of the scanner 30 is connected to the scanner image processor 31 and the output of the scanner image processor 31 is connected to the page memory 27. Also, the page memory 27 is connected to the printer image processor 32 and the printer image processor 32 is connected to the printer 33.

The CPU 21 controls the above-described each circuit or function of the MFP 20 collectively in accordance with a control program stored in the ROM 22. The RAM23 provides a work area in which various kinds of information or data are stored temporarily. Such information or data are used by the CPU 21 when the CPU 21 performs its control processes.

Following functions are respectively effected by the MFP 20 when the CPU 21 performs the control program stored in the ROM 22.

1) A color copying function which carries out a color copy of a color original.

2) A color printing function which carries out a print of data received by the MFP 20 from the PC 39, for example, through the network 38.

3) A network scanning function in which an image data read by the scanner 30 is output from the MFP 20 to the PC 39 through the network 38.

4) A storage function in which a scanned image data is stored in the HDD 28,

5) A data management function which carries out management of an image data file stored in the HDD 28.

The clock generator 24 produces clock pulses and outputs time information indicating a present time.

The control panel 25 has keys and a display, e.g., a liquid crystal display 40. Various kinds of command by a user are inputted through the keys. For example, the keys include a start key to effect a color copying function. The liquid crystal display 40 displays an image based on the image data of a predetermined format, such as RGB format, under the control of the CPU 21.

The controller 26 reads out a data stored in the HDD 28. On the other hand, the controller 26 outputs a data to the HDD 28 when controller 26 receives the data from the PC 39 connected through the network 38.

Moreover, the controller 26 outputs a data from the data format converter 29 to the PC 39 through the network 38. The controller 26 may receive an image data from the PC 39 in various data formats and thus controller 26 converts the format of the image data into YMCK format.

The page memory 27 stores an image data inputted from the scanner image processor 31, and outputs the image data to the HDD 28. Moreover, the page memory 27 stores the image data read from the HDD 28, and outputs the image data to the printer image processor 32.

The HDD 28 stores the image data outputted from the page memory 27 and the controller 26.

The scanner 30 scans an image of the original laid on a platen (not shown), and generates an image data of the scanned image. That is, light from a light source (not shown) irradiates on an original and is reflected therefrom.

An RGB sensor receives the reflected light and outputs analog signals corresponding to blue, green and red light element of the light, respectively. The analog signals are respectively amplified by an amplifier and are converted into digital signals by an A/D converter. Then, the digital signals are processed by correction circuits such as, e.g., a shading correction circuit, a nonlinear correction circuit, to generate an image data in RGB format.

The image data is further image-processed by the scanner image processor 31, such as, e.g., a color conversion processing, a filtering, and a resolution transform, under the control of the CPU 21. As a result, the format of the image data is changed from RGB to YMC. The scanner image processor 31 further processes a compression processing on the image data.

However, when the network scanning function is effected, the scanner image processor 31 may output the image data in RGB format without performing the image processing described above, or may output image data in YCbCr format, which is preprocessed for JPEG format.

The printer image processor 32 performs image processing, such as, e.g., an extension processing, a black-component-generation processing, and a halftone processing, to the image data read from the HDD 28 through the page memory 27 under the control of the CPU 21. As a result, the format of the image data is changed to YMCK.

The printer 33 prints an image on a sheet based on the image data.

Operation of the data format converter 29 will be described below. The operation of the data format converter 29 is different in a data conversion processing in each case of the MFP 20 that the color copying function is effected, the color printing function is effected or the network scanning function is effected. Thus, the operation of the data format converter 29 in each case will be described respectively.

In the color copying function of the MFP 20, the scanner image processor 31 performs the color-conversion processing and the filtering to the image data of RGB format generated by the scanner 30 from an original, and converts the format of the image data to YMC. The format of the image data is finally converted into YCbCr by compression processing. The image data is stored in the HDD 28 through the page memory 27.

The data format converter 29 reads the image data out of the HDD 28, and extends it. The format of the image data is changed to YMC. The format of the image data is then converted from YMC to RGB when a user requests to display the image based on the image data stored in the HDD 28 in the color copying function.

In the color printing function of the MFP 20, an image data is sent to the HDD 28 from the PC 39 through the network 38 and the controller 26 and is stored in the HDD 28 in YMCK format. The data format converter 29 reads out the image data from the HDD 28, and converts the format of the image data from YMCK to RGB when a user requests to display the image based on the image data stored in the HDD 28 in the color printing function.

In the color network scanner function of the MFP 20, the image data generated from the original by the scanner 30 is stored in the HDD 28, or the format of the image data is once converted to YCbCr and is stored in the HDD 28. The data format converter 29 reads out the image data in YCbCr format from the HDD 28, and converts the format of the image data from YCbCr to RGB when a user requests to display the image based on the image data stored in the HDD 28 in the color copying function.

However, if the image data is stored in the HDD 28 in RGB format, the data format converter 29 simply reads out the image data from the HDD 28, no further data conversion is required.

As described above, the data format converter 29 can convert the format of an image data from two or more kind of formats such as YMC, YMCK, and YCbCr, to RGB format.

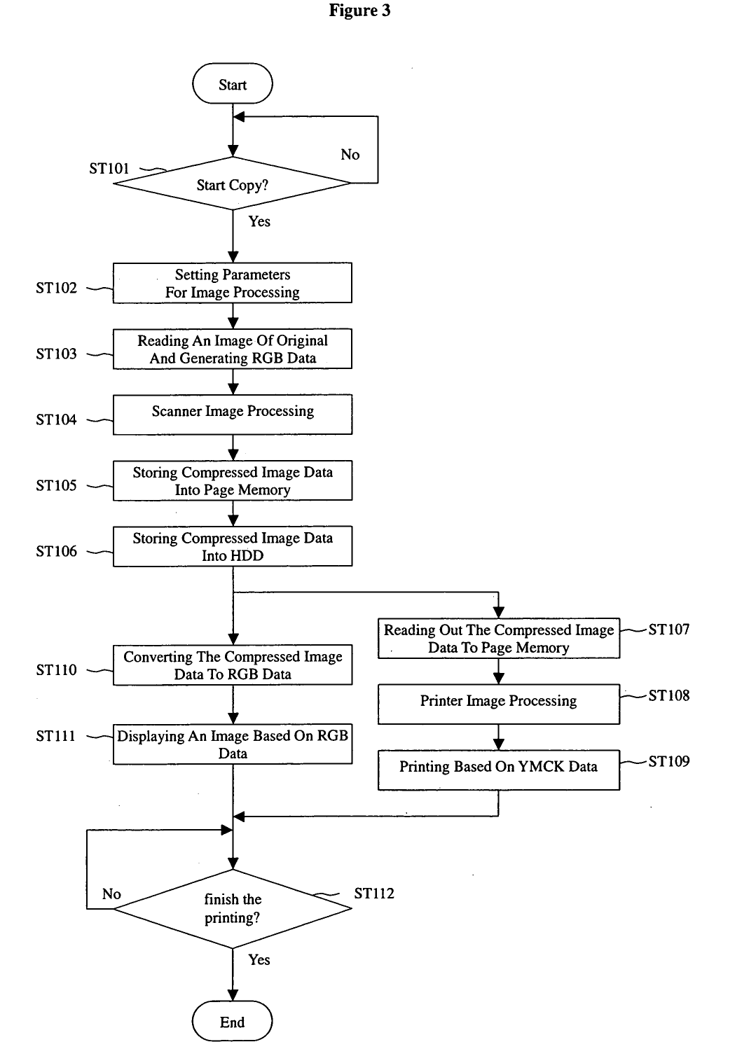

Operation of the MFP 20 in which the color copying function is selected will be described with reference to FIG. 3.

In a step ST101, the MFP 20 is in a standby state. If the CPU 21 detects an input of the start key from the control panel 25, the Yes-path is taken and the copying operation is initiated in a step ST102. Otherwise, the No-path is taken and the MFP 20 maintains its standby state.

In the step ST102, the CPU 21 sets parameters to the scanner image processor 31 and the printer image processor 32 respectively for color image processing, and also sets parameters to the data format converter 29 for data convert processing.

In a step ST103, the original is scanned and the image data in RGB format is generated from the original by the scanner 30 under the control of the CPU 21. The image data is outputted to the scanner image processor 31.

In a step ST104, the scanner image processor 31 performs the image processing including color conversion and filtering to the inputted image data. Parameters for image processing for color copying are set by the CPU to the scanner image processor 31 beforehand in the step ST102. Then, the format of the image data is converted from RGB to YMC and the image data is further compressed to output the image data in YCbCr format from the scanner image processor 31.

In a step ST105, the image data outputted from the scanner image processor 31 is stored in the page memory 27, temporarily.

In a step ST 106, the image data stored in the page memory 27 is then read out and stored in the HDD 28. This is the storage function. The HDD 28 stores the image data as an image data file. The image data file also has a header information data indicating, for example, a file name and an image data format information. The image data format information indicates the format of the image data. A file name is given based on the time information from the clock generator 24. For example, the time or the date information that the CPU 21 obtains from the clock generator 24 when the file is made is used as a file name. The image data file is managed by the data management function.

After that, the CPU 21 reads out the image data and the image data format information from the HDD 28 to the page memory 27, and outputs it to the data format converter 29 in accordance with a user request for displaying an image data in the HDD 28.

In a step ST107, the image data read out to the page memory 27 is outputted to the printer image processor 32.

In a step ST108, the printer image processor 32 performs the image processing to the compressed image data. Parameters for the image processing for color copying are set to the printer image processor 32 beforehand in the step ST102. The image data is extended and the black-component-generation processing is performed to the image data. As a result, the format of the image data is changed to YMCK. After that, the Halftone processing is performed to the image data. Then, the printer image processor 32 outputs the image data to the printer 33.

In a step ST109, the printer 33 carries out its printing operation based on the image data of YMCK format from the printer image processor 32 under the control of the CPU 21. In a step ST112, if the CPU 21 detects the finish of the printing operation by the printer 33, the Yes-path is taken. Otherwise, the No-path is taken.

In a step ST110, the data format converter 29 extends the image data fed from the HDD 28 and converts the format of the image data to RGB format based on the image data format information, if required. The data format of the image data is discriminated based on the image data format information. The image data is then outputted to the control panel 25. In a step ST111, the liquid crystal display 40 of the control panel 25 displays an image based on the image data of RGB format. The image display by the liquid crystal display 40 is maintained until the present copying operation is ended in the step ST112. As can be understood from FIG. 3, steps ST107, ST108 and ST109 and steps ST110 and ST111 are executed in parallel.

In these steps ST110 and ST111, a user may select whether the image is displayed on the liquid crystal display 40 of the control panel 25 or not. Moreover, in the step ST111, the user may also select whether the image is displayed on either a monitor of the PC 39 connected through the network 38 or the liquid crystal display 40 of the control panel 9. These selection or setup are performed by the user through the control panel 25 of the MFP 20.

In the MFP 20 having the above-described configuration, the image data generated by the scanner 30 in RGB format is compressed and stored in the HDD 28. Since the data size stored in the HDD 28 is reduced, the memory space of the HDD 28 where the data is stored can be reduced. The format of the image data fed from the HDD 28 is converted to YMCK to carry out the printing operation by the printer 33 based on the image data. The format of the image data also is converted to RGB to carry out the image display by the liquid crystal display 40 of the control panel 9 or by the monitor of the PC 12 based on the image data.

Moreover, the image data stored in the HDD 28 by the storage function when the color copying operation was performed is managed with its file name as mentioned above. If a user requests to display a list of file names of image data stored in the HDD 28 on the liquid crystal display 40 to select a desired file name from the list, the image data associated with the file name is displayed on the liquid crystal display 40 for the user. Therefore, the user can confirm the image data stored in the HDD 28 and can select a desired file without printing images based on the image data.

On the other hand, in response to the command from the control panel 25, an image based on the image data stored in the HDD 28 may be displayed on the monitor of the PC 39 connected to the MFP 20 through the network 38.

The above is an explanation when the color copying function of the MFP 20 is selected. However, the same operation in which the data is stored in the HDD 28 by the storage function is also performed when the color printing function or the network scanning function is selected.

When the MFP 20 carries out the printing operation based on an image data received from the PC 39, the image data from the PC 39 is stored in the HDD 28 after converting the format of the image data to YMCK by the controller 26. This image data stored in the HDD 28 is used to carry out the printing operation by the MFP 20. To manage this image data stored in the HDD 28 by the data management function of the MFP 20, a file name is given to the image data as described above.

When the image data inputted from the scanner 30 and preprocessed for conversion to JPEG format is outputted to the PC 39 through the network 38, the scanner image processor 31 converts the format of the image data from RGB to YCbCr, and the HDD 28 stores the image data in YCbCr format through the page memory 27. That is, when the MFP 20 performs the network scanning function, the image data is stored in the HDD 28 in YCbCr format. A file name of the image data is given by the data management function when the image data is stored in the HDD 28. In addition, when an image processing is not performed to the image data, the HDD 28 stores the image data in RGB format.

As described above, when the MFP 20 performs the color printing function, an image data is stored in the HDD 28 in YMCK format. When the MFP 20 performs the network scanning function, an image data is stored in the HDD 28 in YCbCr format. In case that the image data is formatted in YMCK or YCbCr, as described above, the data format converter 29 can detect from the image data format information which one of the formats (YMCK and YCbCr) is used to the image data and can properly convert the detected format to RGB format to display an image based on the image data on the liquid crystal display 40 of the control panel 25.

According to the present invention, the image data stored in the HDD 28 in various formats is properly converted to the image data in a predetermined format which is used to display an image based on the image data. Therefore, an image based on the image data in the predetermined format can be displayed on the display of the MFP 20 or the monitor of the PC 39 through the network 38 and thus, a user can confirm or see the image data visually without printing the image data on a paper.

In the above described embodiment, a description is given that an image is formatted in one of YMCK format, YCbCr format and RGB format. However, data formats other than the above can be applicable, including those already known and any others that would be readily apparent to one of ordinary skill in the art after reading this disclosure.

Furthermore, in a monochrome MFP, an image data stored in a HDD as a monochrome image data can be displayed on a color display by converting the monochrome image data into an image data in which each amount of R, G, and B is equal to one another.

What is claimed is:

1. An image forming apparatus, comprising:
a storage configured to store an image data of a first format,
a display configured to display an image based on an image data of a predetermined format, and
a data format converter configured to convert the image data of the first format stored in the storage to the image data of the predetermined format when the image data in the first format stored in the storage is visually displayed on the display as an image.

2. An apparatus according to claim 1, wherein the storage is configured to store the image data in the first format selected from at least RGB, YMC, YCbCr, and YMCK formats.

3. An apparatus according to claim 2, wherein the data format converter is configured to be capable of converting the image data of the first format selected from at least YMC, YMCK and YCbCr formats to the image data of the predetermined format.

4. An apparatus according to claim 3, wherein the predetermined format is RGB format.

5. An apparatus according to claim 1, wherein the image data is stored with an image data format information in the storage, and the data format converter is configured to convert the image data of the first format to the image data of the predetermined format according to the image data format information.

6. An apparatus according to claim 5, wherein the predetermined format is RGB format.

7. An image forming apparatus according to claim 1, wherein the data format converter is configured to convert the image data of the first format stored in the storage to the image data of the predetermined format if the first format is different from the predetermined format when the image data in the first format stored in the storage is visually displayed on the display as an image.

8. An image forming apparatus according to claim 1, wherein the data format converter is configured to convert the image data of the first format stored in the storage to the image data of the predetermined format when the image data in the first format stored in the storage is visually displayed on the display as an image in accordance with a user request.

9. An image forming apparatus, comprising:
a storage means for storing an image data of a first format with an image data format information,
a display means for displaying an image based on an image data of a predetermined format, and
a data format converter means for converting the image data of the first format stored in the storage means to the image data of the predetermined format according to the image data format information when the image data of the first format stored in the storage means is visually displayed on the display means as an image.

10. An image forming apparatus according to claim 9, wherein the data format converter means converts the image data of the first format stored in the storage to the image data of the predetermined format if the first format is different from the predetermined format when the image data in the first format stored in the storage is visually displayed on the display as an image.

11. A method for displaying an image based on an image data of various formats, wherein the image data in a first format is stored with an image data format information in a storage and an image is displayed on a display based on the image data of a predetermined format, comprising:
discriminating the first format of the image data based on the image data format information,
converting the image data of the first format to the image data of the predetermined format according to the result of the discrimination, and
visually displaying the image data of the predetermined format as an image.
